(19) United States
(12) Patent Application Publication
(10) Pub. No.: US 2020/0187190 A1
(43) Pub. Date: Jun. 11, 2020

(54) Synchronization Method and Apparatus

(71) Applicant: Huawei Technologies Co., Ltd., Shenzhen (CN)

(72) Inventors: Lei Gao, Beijing (CN); Deping Liu, Beijing (CN); Zhenwei Lu, Beijing (CN)

(21) Appl. No.: 16/791,444

(22) Filed: Feb. 14, 2020

Related U.S. Application Data
(63) Continuation of application No. PCT/CN2018/099258, filed on Aug. 7, 2018.

(30) Foreign Application Priority Data
Aug. 17, 2017 (CN) 201710708136.1

(51) Int. Cl. H04W 72/04; H04W 56/00

(52) U.S. Cl. CPC H04W 72/048; H04W 56/001; H04W 72/044

(57) ABSTRACT

This application provides a synchronization method and an apparatus. The method includes: mapping, by first UE, to-be-transmitted data and a first sequence to a symbol of a first time unit, to obtain a first signal, where the first sequence is mapped to at least one symbol at a non-starting location of the first time unit; and sending, by the first UE, the first signal to second UE. The second UE receives the first signal, obtains the first sequence, and performs synchronization on the first signal based on the first sequence.

### CROSS-REFERENCE TO RELATED APPLICATIONS

This application is a continuation of International Application No. PCT/CN2018/099258, filed on Aug. 7, 2018, which claims priority to Chinese Patent Application No. 201710708136.1, filed on Aug. 17, 2017. The disclosures of the aforementioned applications are hereby incorporated by reference in their entireties.

### TECHNICAL FIELD

This application relates to the field of communications technologies, and in particular, to a synchronization method and an apparatus.

### BACKGROUND

In recent years, people pay more attention to an internet-of-vehicles technology. An internet-of-vehicles system improves safety and reliability of road traffic and efficiency of traffic through communication between vehicles, transportation facilities and pedestrians. Status information needs to be exchanged periodically between user equipment (UE) in the internet-of-vehicles system to ensure safe driving of vehicles, and therefore is referred to as a periodic status message (PSM). A service cycle of the PSM may change based on a vehicle motion status, and values of service cycles of UEs in different movement statuses are from [100 ms, 1000 ms].

In an internet-of-vehicles system, when two UEs exchange data, signals of the two UEs need to perform time and frequency synchronization to enable a receive-end UE to correctly receive, in a time and frequency synchronization manner, data transmitted by transmit-end UE. In a current synchronization manner, UEs separately perform time and frequency synchronization based on a downlink synchronization signal sent by a base station. However, a 5G network (NR) technology needs to support a higher frequency band and a larger bandwidth than long term evolution (LTE), and therefore a plurality of optional combinations of a subcarrier spacing (SCS) and cyclic prefix (CP) (including a normal cyclic prefix (NCP) and an extended cyclic prefix (ECP)) duration are designed. Table 1 shows some combinations of an SCS and CP duration that are supported in a current standard discussion.

TABLE 1
Some combinations of an SCS and CP duration that
are supported in an NR standard discussion

| | | |
|---|---|---|
| SCS (corresponding | | |
| to duration of a | | |
| symbol without a CP) | NCP duration | ECP duration |

| | | | | |
|---|---|---|---|---|
| 15 | kHz (67 μs) | 4.7 | μs (5.2 μs) | 17 μs |
| 30 | kHz (33 μs) | 2.3 | μs (2.9 μs) | 8.3 μs |
| 60 | kHz (17 μs) | 1.2 | μs (1.7 μs) | 4.2 μs |
| 120 | kHz (8.3 μs) | 0.59 | μs (1.1 μs) | 2.1 μs |
| 240 | kHz (4.2 μs) | 0.29 | μs (0.81 μs) | 1.0 μs |
| 480 | kHz (2.1 μs) | 0.15 | μs (0.67 μs) | 0.52 μs |

Based on the combinations of the SCS and the CP provided in Table 1, if the UEs are synchronized by using the downlink synchronization signal delivered by the base station, referring to performance and requirement parameters of long term evolution (LTE), a frequency error of the base station is ±0.05 PPM, a frequency synchronization error of the UEs for the received downlink synchronization signals is ±0.1 PPM, a highest speed of the UEs is 250 km/h, and a Doppler shift between UE and the base station and a Doppler shift between the UEs, an offset between data received by the UEs and a carrier frequency of the UEs may be any value between −_{78.5} kHz and _{78.5} kHz (including −_{78.5} kHz and _{78.5} kHz). When an SCS is less than a maximum frequency offset, the UE cannot perform frequency offset estimation on the received data. Therefore, SCS≥120 kHz. Considering a case of SCS≥120 kHz, a maximum communication distance 300 m between UEs is used as an example for calculation. A maximum time difference between arrival of a downlink synchronization signal at different UEs is 1 μs, and a maximum propagation delay of data from transmit UE to receive UE is 1 μs. In this case, a difference between a time at which the UE receives the data and a timing of the UE may be any value between 0 μs and 2 μs (including 0 Ξs and 2 μs). Therefore, CP duration should be greater than 2 μs; otherwise, if data receiving time exceeds a CP range, the data cannot be correctly received. In this case, only the combination of SCS=120 kHz and an ECP can be selected. Even if this combination is selected, if CP duration is 2 .1 μs, when a difference between a time at which the data is received and a timing of the UE is 2 μs, only remaining 0.1 μs covers a delay spread of a channel. Considering that antenna heights of a transmitter and a receiver in V2V communication are comparatively low, and a signal propagation environment is complex, a delay spread is comparatively larger. In this case, the remaining CP duration of 0.1 μs cannot resolve a problem caused by the delay spread.

In conclusion, the foregoing synchronization manner cannot meet a requirement of time synchronization between two UEs in an internet-of-vehicles system.

### SUMMARY

This application provides a synchronization method and an apparatus, to resolve a problem that the foregoing synchronization manner cannot meet a requirement of time synchronization between two UEs in an internet-of-vehicles system.

A first aspect of this application provides a synchronization method, and the method includes: mapping, by first UE, to-be-transmitted data and a first sequence to a symbol of a first time unit, to obtain a first signal, where the first sequence is mapped to at least one symbol of the first time unit except the 1^{st} symbol, and the first sequence is used by second UE to perform synchronization the first signal; and sending, by the first UE, the first signal to the second UE.

The first sequence is mapped to one or more symbols at a non-starting location of the first time unit.

Optionally, the symbol to which the first sequence is mapped is a symbol that includes a CP.

In this solution, it should be understood that the second UE may not only synchronize the first signal by using the first sequence, but also perform measurement, channel estimation, and the like based on the first sequence. In this solution, the first sequence used for user synchronization is sent in a symbol of a non-starting part of each data transmission, so that when CP duration of a data sending symbol cannot satisfy a time synchronization requirement, the second UE can still implement time synchronization on currently received data by using the first sequence, and implement frequency synchronization by performing frequency offset estimation by using a CP structure.

Optionally, duration of a cyclic prefix of the symbol to which the first sequence is mapped is greater than duration of a cyclic prefix of a symbol to which the data is mapped.

Optionally, a subcarrier spacing of the symbol to which the first sequence is mapped is greater than a subcarrier spacing of the symbol to which the data is mapped.

Optionally, the duration of the cyclic prefix of the symbol to which the first sequence is mapped is less than duration of the symbol to which the first sequence is mapped. This solution is different from a solution in which the first sequence is mapped to two consecutive CP-free symbols, thereby reducing unnecessary overheads.

Optionally, the mapping, by first UE, a first sequence to a symbol of a first time unit includes: consecutively mapping, by the first UE, the first sequence in a frequency domain corresponding to a symbol corresponding to the first sequence, where a remaining frequency domain part is filled with o or the first sequence is cyclically mapped to a remaining frequency domain part.

In this solution, a mapping mode is continuous mapping in the frequency domain, and a part that is not covered by the continuous mapping is filled with 0 or the first sequence is cycled (the cycling is similar to a mapping mode of an uplink DMRS in LTE). When a cyclic mapping mode is used, the first sequence may be used for channel estimation.

Optionally, a second sequence is mapped to at least one symbol, starting from the 1^{st} symbol, of the first time unit (at least one symbol at the starting location of the first time unit), and the second sequence is a QPSK sequence, a BPSK sequence, or a CAZAC sequence.

Optionally, a subcarrier spacing of the 1^{st} symbol to which the second sequence is mapped is greater than the subcarrier spacing of the symbol to which the data is mapped.

In a specific implementation, the 1^{st} symbol may include no cyclic prefix, so that AGC overheads are smaller, and a longer time is left for a CP of the synchronization symbol. In this way, a time synchronization algorithm has higher tolerance to a timing offset.

Optionally, the first sequence is mapped to the 2^{nd} symbol of the first time unit.

Optionally, when the second sequence is mapped to the 1^{st} symbol of the first time unit, the first sequence is mapped to the 2^{nd} symbol of the first time unit.

When the second sequence is mapped to a plurality of symbols, starting from the 1^{st} symbol, of the first time unit, the first sequence is mapped to a symbol following the symbols for the second sequence.

Optionally, the first time unit includes: one subframe, one TTI, one sTTI, a plurality of bundled consecutive TTIs, or a plurality of bundled consecutive sTTIs.

Optionally, before the mapping, by first UE, to-be-transmitted data and a first sequence to a symbol of a first time unit, to obtain a first signal, the method further includes: determining the first sequence based on a preconfigured synchronization sequence set; obtaining the first sequence preconfigured in a protocol; or determining the first sequence based on received information sent by a base station.

It can be learned from the foregoing technical solution that, in this solution, synchronization enhancement is performed based on initial synchronization. Due to the CP structure of the symbol to which the first sequence is mapped, the second UE may implement time synchronization by using a frequency domain synchronization algorithm when an initial time synchronization error is less than the CP duration of the symbol to which the first sequence is mapped. Compared with a time-domain-related synchronization algorithm, the frequency domain synchronization algorithm has lower complexity. An additional beneficial effect brought by longer CP duration is that the frequency domain algorithm can tolerate a larger initial time synchronization error. In addition, the CP structure may be used for frequency synchronization, and a longer CP indicates more points used for frequency synchronization and higher frequency synchronization precision.

A second aspect of this application provides a synchronization method, and the method includes: receiving, by second UE, a first signal sent by first UE, where the first signal includes data and a first sequence, and the first sequence is mapped to at least one symbol of a first time unit except the 1^{st} symbol; and performing, by the second UE, synchronization on the first signal based on the first sequence.

Optionally, the performing, by the second UE, synchronization on the first signal based on the first sequence includes: obtaining, by the second UE, a frequency offset and a timing offset between the data and a carrier frequency; and obtaining, by the second UE based on the frequency offset and the timing offset, the data transmitted in the first signal.

Optionally, duration of a cyclic prefix of the symbol to which the first sequence is mapped is greater than duration of a cyclic prefix of a symbol to which the to-be-transmitted data is mapped.

Optionally, a subcarrier spacing of the symbol to which the first sequence is mapped is greater than a subcarrier spacing of the symbol to which the data is mapped.

Optionally, the duration of the cyclic prefix of the symbol to which the first sequence is mapped is less than duration of the symbol to which the first sequence is mapped.

Optionally, a second sequence is mapped to at least one symbol, starting from the 1^{st} symbol, of the first time unit, and the second sequence is a QPSK sequence, a BPSK sequence, or a CAZAC sequence.

Optionally, a subcarrier spacing of the 1^{st} symbol to which the second sequence is mapped is greater than the subcarrier spacing of the symbol to which the data is mapped.

Optionally, the receiving, by second UE, a first signal sent by first UE includes: receiving, by the second UE, the first sequence in the 2^{nd} symbol of the first time unit.

This solution means that the first sequence is mapped to the 2^{nd} symbol of the first time unit.

Optionally, when the second sequence is mapped to the 1^{st} symbol of the first time unit, the first sequence is mapped to the 2^{nd} symbol of the first time unit.

When the second sequence is mapped to a plurality of symbols, starting from the 1^{st} symbol, of the first time unit, the first sequence is mapped to a symbol following the symbols for the second sequence.

Optionally, the first time unit includes: one subframe, one TTI, one sTTI, a plurality of bundled consecutive TTIs, or a plurality of bundled consecutive sTTIs.

Optionally, before the performing, by the second UE, synchronization on the first signal based on the first sequence, the method further includes: detecting the first signal based on a preconfigured synchronization sequence set, to obtain a sequence that is carried in the first signal and that belongs to the synchronization sequence set, and determining the sequence as the first sequence; detecting the first signal based on a synchronization sequence preconfigured in a protocol, to obtain the first sequence; or detecting the first signal based on a synchronization sequence determined by using received information sent by a base station, to obtain the first sequence.

A third aspect of this application provides a synchronization apparatus. The apparatus includes: a processing module, configured to map to-be-transmitted data and a first sequence to a symbol of a first time unit, to obtain a first signal, where the first sequence is mapped to at least one symbol of the first time unit except the 1^{st} symbol, and the first sequence is used by second UE to perform synchronization the first signal; and a sending module, configured to send the first signal to the second UE.

Optionally, duration of a cyclic prefix of the symbol to which the first sequence is mapped is greater than duration of a cyclic prefix of a symbol to which the data is mapped.

Optionally, a subcarrier spacing of the symbol to which the first sequence is mapped is greater than a subcarrier spacing of the symbol to which the data is mapped.

Optionally, the duration of the cyclic prefix of the symbol to which the first sequence is mapped is less than duration of the symbol to which the first sequence is mapped.

Optionally, the mapping, by first UE, a first sequence to a symbol of a first time unit includes: consecutively mapping, by the first UE, the first sequence in a frequency domain corresponding to a symbol corresponding to the first sequence, where a remaining frequency domain part is filled with 0 or the first sequence is cyclically mapped to a remaining frequency domain part.

Optionally, a second sequence is mapped to at least one symbol, starting from the 1^{st} symbol, of the first time unit, and the second sequence is a QPSK sequence, a BPSK sequence, or a CAZAC sequence.

Optionally, a subcarrier spacing of the 1^{st} symbol to which the second sequence is mapped is greater than the subcarrier spacing of the symbol to which the data is mapped.

Optionally, the first sequence is mapped to the 2^{nd} symbol of the first time unit.

Optionally, when the second sequence is mapped to the 1^{st} symbol of the first time unit, the first sequence is mapped to the 2^{nd} symbol of the first time unit.

When the second sequence is mapped to a plurality of symbols, starting from the 1^{st} symbol, of the first time unit, the first sequence is mapped to a symbol following the symbols for the second sequence.

Optionally, the first time unit includes: one subframe, one TTI, one sTTI, a plurality of bundled consecutive sTTIs, or a plurality of bundled consecutive TTIs.

Optionally, the processing module is further configured to: determine the first sequence based on a preconfigured synchronization sequence set; obtain the first sequence preconfigured in a protocol; or determine the first sequence based on received information sent by a base station.

A fourth aspect of this application provides a synchronization apparatus. The apparatus includes: a receiving module, configured to receive a first signal sent by first UE, where the first signal includes data and a first sequence, and the first sequence is mapped to at least one symbol of a first time unit except the 1^{st} symbol; and a processing module, configured to perform synchronization on the first signal based on the first sequence.

Optionally, the processing module is specifically configured to: obtain a frequency offset and a timing offset between the data and a carrier frequency; and obtain, based on the frequency offset and the timing offset, the data transmitted in the data signal.

Optionally, duration of a cyclic prefix of the symbol to which the first sequence is mapped is greater than duration of a cyclic prefix of a symbol to which the to-be-transmitted data is mapped.

Optionally, a subcarrier spacing of the symbol to which the first sequence is mapped is greater than a subcarrier spacing of the symbol to which the data is mapped.

Optionally, the duration of the cyclic prefix of the symbol to which the first sequence is mapped is less than duration of the symbol to which the first sequence is mapped.

Optionally, a second sequence is mapped to at least one symbol, starting from the 1^{st} symbol, of the first time unit, and the second sequence is a QPSK sequence, a BPSK sequence, or a CAZAC sequence.

Optionally, a subcarrier spacing of the 1^{st} symbol to which the second sequence is mapped is greater than the subcarrier spacing of the symbol to which the data is mapped.

Optionally, the receiving, by second UE, a first signal sent by first UE includes: receiving, by the second UE, the first sequence in the 2^{nd} symbol of the first time unit.

That is, the first sequence is mapped to the 2^{nd} symbol of the first time unit.

Optionally, when the second sequence is mapped to the 1^{st} symbol of the first time unit, the first sequence is mapped to the 2^{nd} symbol of the first time unit.

When the second sequence is mapped to a plurality of symbols, starting from the 1^{st} symbol, of the first time unit, the first sequence is mapped to a symbol following the symbols for the second sequence.

Optionally, the first time unit includes: one subframe, one TTI, one sTTI, a plurality of bundled consecutive TTIs, or a plurality of bundled consecutive sTTIs.

Optionally, the processing module is further configured to: detect the first signal based on a preconfigured synchronization sequence set, to obtain a sequence that is carried in the first signal and that belongs to the synchronization sequence set, and determine the sequence as the first sequence; detect the first signal based on a synchronization sequence preconfigured in a protocol, to obtain the first sequence; or detect the first signal based on a synchronization sequence determined by using received information sent by a base station, to obtain the first sequence.

A fifth aspect of this application provides user equipment, including a memory, a processor, a transmitter, and a computer program. The computer program is stored in the memory, and the processor runs the computer program to perform the synchronization method according to any implementation of the first aspect.

A sixth aspect of this application provides user equipment, including a memory, a processor, a receiver, and a computer program. The computer program is stored in the memory, and the processor runs the computer program to perform the synchronization method according to any implementation of the second aspect.

During specific implementation of the foregoing user equipment, the memory may be integrated into the processor. There is at least one processor configured to execute an executable instruction stored in the memory, namely, the computer program.

A seventh aspect of this application provides a storage medium, including a readable storage medium and a computer program. The computer program is used to implement the synchronization method according to any implementation of the first aspect.

An eighth aspect of this application provides a storage medium, including a readable storage medium and a computer program. The computer program is used to implement the synchronization method according to any implementation of the second aspect.

A ninth aspect of this application provides a program product. The program product includes a computer program (namely, an executable instruction), and the computer program is stored in a readable storage medium. At least one processor of user equipment may read the computer program from the readable storage medium; and the at least one processor executes the computer program, so that the user equipment implements the synchronization method provided in any implementation of the first aspect or the second aspect.

A tenth aspect of this application provides a chip. The chip is applicable to user equipment, and the chip includes: at least one communications interface, at least one processor, and at least one memory. The communications interface, the memory, and the processor are interconnected by using a bus; and the processor invokes a computer program stored in the memory, to perform the synchronization method provided in the first aspect or the second aspect of this application.

According to the synchronization method and the apparatus that are provided in this application, a first sequence used for user synchronization is sent in a symbol of a non-starting part of each data transmission, so that when CP duration of a data sending symbol cannot satisfy a time synchronization requirement, a receive-end device can still implement time synchronization on currently received data by using the first sequence of the signal, and implement frequency synchronization by performing frequency offset estimation by using a CP structure.

### BRIEF DESCRIPTION OF THE DRAWINGS

FIG. 1 is a flowchart of Embodiment 1 of a synchronization method according to this application;

FIG. 2 is a flowchart of Embodiment 2 of a synchronization method according to this application;

FIG. 3 is a schematic diagram of a preamble sequence in an example of a synchronization method according to this application;

FIG. 4 is a schematic structural diagram of Embodiment 1 of a synchronization apparatus according to this application; and

FIG. 5 is a schematic structural diagram of Embodiment 2 of a synchronization apparatus according to this application.

### DETAILED DESCRIPTION OF ILLUSTRATIVE EMBODIMENTS

According to the solution in the background, if the user equipment (UE) perform synchronization based on the foregoing downlink synchronization signal delivered by the base station, a requirement for time synchronization between two UEs in an internet-of-vehicles system cannot be met.

In 802.11 series communications technologies, a preamble sequence including 12 identical short sequences and two long sequences is sent at the start of each data transmission, to perform automatic gain control (AGC), time and frequency synchronization, and channel estimation. Total time domain duration of the 12 short sequences is three orthogonal frequency division multiplexing (OFDM) symbols without a cyclic prefix (CP), and total time domain duration of the two long sequences is two OFDM symbols without a CP.

However, the 802.11 series communications technologies are asynchronous-system-based communications technologies, and time and frequency synchronization needs to be performed in a large range during each transmission. Consequently, design of a preamble sequence is comparatively complex, and a comparatively large quantity of OFDM symbols are occupied. In addition, in the 802.11 series communications technologies, a comparatively small quantity of subcarriers are usually occupied. Therefore, even if a relatively large quantity of OFDM symbols are occupied, overheads are still comparatively low.

For the foregoing problem, in the technical solution provided in this application, receive UE can synchronously receive data transmitted by all other UEs within the coverage. The “within the coverage” means that a distance from the receive UE is less than or equal to a maximum communication distance between UEs. An NR V2X communications technology is a synchronous-system-based communications technology. Synchronization is already performed to some extent between the UEs, and time and frequency synchronization needs to be performed only in a relatively small range during each transmission. Therefore, time and frequency synchronization may also be implemented by using fewer OFDM symbols than those of a preamble sequence in the 802.11 series technologies.

The synchronization method in this application is applicable to an internet-of-vehicles system, a device-to-device (D2D) system, or other sidelink communications system; a scenario in which UE autonomously selects a sending resource; and a case with or without network-side device participation. The synchronization method is used between terminal devices (user equipment). The terminal device includes but is not limited to a vehicle, handheld user equipment, or the like, and may communicate with a network-side device, or may directly communicate with another terminal device.

The network-side device is a device with a radio resource management function that can communicate with a terminal device or serves as a central controller to assist in direct communication between terminals, for example, a base station.

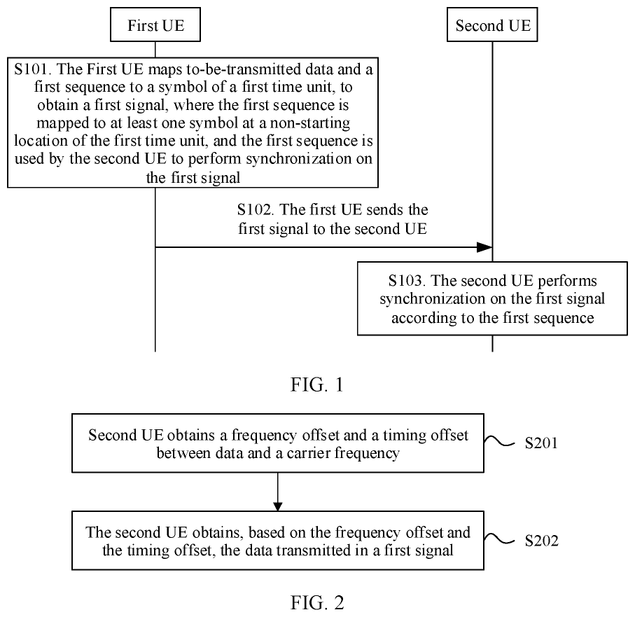

FIG. 1 is a flowchart of Embodiment 1 of a synchronization method according to this application. As shown in FIG. 1, the synchronization method is applied to an interaction process between two UEs, and specifically includes the following steps.

S101. First UE maps to-be-transmitted data and a first sequence to a symbol of a first time unit, to obtain a first signal, where the first sequence is mapped to at least one symbol of the first time unit except the 1^{st} symbol, and the first sequence is used by second UE to perform synchronization the first signal.

In this step, when the transmit-end UE needs to send data to the receive-end UE, the transmit-end UE obtains the first sequence used for synchronization, and maps the first sequence and the data together to corresponding resources when mapping the to-be-sent data to a resource. In the mapping process, the first sequence is mapped to one or more consecutive symbols at a non-starting location of a current transmission period, namely, the first time unit. For example, the first sequence is mapped to the 2^{nd} symbol, the 2^{nd} symbol and the 3^{rd} symbol, or the N^{th} symbol, or several symbols starting from the N^{th} symbol, where N is greater than 1. The first sequence is mapped to the non-starting location, avoiding a problem that a synchronization sequence is distorted and a synchronization effect is affected due to AGC of a receiver.

Correspondingly, the to-be-transmitted data may be mapped to symbols at a starting location and other idle locations of the first time unit.

In this solution, it should be understood that the first time unit is a time unit for each data transmission, and includes at least the following cases: one subframe, one TTI (or sTTI), or a plurality of bundled TTIs (or sTTIs).

The symbol in this solution may be an OFDM symbol, a single carrier frequency division multiple access (SC-FDMA) symbol, or the like. The SC-FDMA symbol is also referred to as a DFT-F-OFDM symbol, or an OFDM symbol for precoding transmission.

In this solution, in addition to use for synchronizing the first signal, the first sequence may be further used for measurement, channel estimation, and the like. The first sequence may be a ZC sequence, or an M sequence modulated by using binary phase shift keying (BPSK), or may be another sequence. This is not limited in this solution.

Optionally, in a specific implementation of this solution, a specific manner of determining the first sequence by the first UE includes at least the following several manners.

In a first manner, the first UE determines the first sequence based on a preconfigured synchronization sequence set. To be specific, the network-side device configures, for the UE, the synchronization sequence set dedicated for synchronization, and the network-side device may directly select a proper first sequence from the synchronization sequence set as required by the UE.

In a second manner, the first UE obtains the first sequence preconfigured in a protocol.

This solution means that the first sequence is specified in a protocol, that is, a synchronization sequence used for transmission between user equipment is specified in the protocol, and when the UE needs to use the first sequence, the UE directly reads the sequence from the protocol.

In a second manner, the first UE determines the first sequence based on received information sent by a base station.

In this solution, the base station or another network-side device may send, to the UE, information used to indicate the first sequence. The information may directly carry the first sequence, or may indicate a rule, a path, or the like for obtaining the first sequence. The UE determines the first sequence based on the received information.

S102. The first UE sends the first signal to the second UE.

In this solution, after the to-be-transmitted data and the first sequence are mapped to corresponding resources to obtain the signal, the signal is sent to the second UE, so that the second UE receives the first signal that includes the data and the second sequence used for synchronization.

S103. The second UE performs synchronization on the first signal based on the first sequence.

In this step, in the process of receiving the first signal, the second UE needs to obtain the first sequence used for synchronization from the first signal, and synchronizes the first signal, namely, the data signal, based on the first synchronization sequence, to accurately obtain the data sent by the first UE.

Similar to the first UE, the second UE may also obtain the first sequence from the first signal in the following manners.

In a first manner, the second UE detects the first signal based on a preconfigured synchronization sequence set, to obtain a sequence that is carried in the first signal and that belongs to the synchronization sequence set, and determines the sequence as the first sequence.

During reception detection on a signal, reception detection is performed on the first signal based on a local synchronization sequence set preconfigured by the network-side device or in another manner, the sequence is detected and obtained at a corresponding location, and the sequence belonging to the synchronization sequence set is determined as the first sequence.

In a second manner, the first signal is detected based on a synchronization sequence preconfigured in a protocol, to obtain the first sequence.

In a second manner, the first signal is detected based on a synchronization sequence determined by using received information sent by a base station, to obtain the first sequence.

According to the synchronization method provided in this embodiment, the first sequence used for synchronization is carried in a data transmission signal each time data is transmitted, so that when CP duration of a data sending symbol cannot satisfy a time synchronization requirement, the receive-end device can still implement time synchronization on the currently received data by using the first sequence, and implement frequency synchronization by performing frequency offset estimation by using a CP structure.

FIG. 2 is a flowchart of Embodiment 2 of a synchronization method according to this application. As shown in FIG. 2, based on Embodiment 1, that the second UE receives the first signal and performs synchronization based on the first sequence in S103 specifically includes the following steps.

S201. The second UE obtains a frequency offset and a timing offset between the data and a carrier frequency.

In this step, the timing offset is an offset between a data arrival time received by the receiver and timing of the receiver itself. The timing offset may be eliminated by performing synchronization by using the first sequence.

S202. The second UE obtains, based on the frequency offset and the timing offset, the data transmitted in the first signal.

In a specific implementation of this solution, a method for determining the timing offset is as follows: A received symbol to which the first sequence is mapped is changed to a frequency domain based on current timing (where the current timing is determined by synchronizing with a global navigation satellite system (GNSS), a base station, or another UE, and/or is determined based on power detection in a period of time that elapses after current transmission starts). Pointwise multiplication is performed in a frequency domain on a conjugate of a location corresponding to the first sequence to obtain a frequency domain channel; the frequency domain channel is changed to a time domain and a modulus value is obtained; and the timing offset for this transmission is determined based on a location with a maximum modulus value. This is a low-complexity frequency domain synchronization algorithm.

Another method is a time-domain synchronization algorithm with comparatively high complexity: A time domain sequence that uses a sampling point as a starting point and whose duration is duration of the symbol to which the first sequence is mapped is selected from the received first signal, and cross-correlation to time domain representation of the first sequence is performed to obtain a modulo value; a time range is determined based on current timing and a maximum timing offset that may occur, and the foregoing steps of cross-correlation and modulo obtaining are repeated by using all sampling points in a traversal range as starting points; and the timing offset for this transmission is determined based on a starting point location corresponding to the maximum modulus value.

The timing of the current transmission is determined based on the obtained timing offset, and a starting location of a discrete Fourier transform algorithm (FFT) window is modulated, to implement time synchronization.

A frequency offset determining method is as follows: A frequency offset of the current transmission relative to the receiver is determined based on time domain duration of the symbol excluding the CP and a phase difference between a time domain sequence of equal duration starting from the end of the symbol and a time domain sequence that is in the CP of the symbol to which the first sequence is mapped and that is not affected by AGC.

A phase of each time domain sampling point of the first signal is adjusted based on the obtained frequency offset, to perform frequency offset correction on the first signal, and further implement frequency synchronization for this transmission.

The data transmitted by using the first signal may be accurately obtained by performing the foregoing processing of time synchronization and frequency synchronization.

In this solution, the first sequence used for synchronization is also carried in the data transmission signal each time the data is transmitted, so that when CP duration of a data sending symbol cannot satisfy a time synchronization requirement, the receive-end device can still implement time synchronization on the currently received data by using the first sequence and a low-complexity algorithm used for implementing time synchronization by solving a time-domain channel, and implement frequency synchronization by performing frequency offset estimation by using a CP structure.

In specific implementation of the foregoing two embodiments, in the first signal, the duration of the cyclic prefix of the symbol to which the first sequence is mapped is greater than the duration of the cyclic prefix of the symbol to which the data is mapped. Synchronization enhancement is performed based on initial synchronization in the technical solution of this application; when the CP structure implements that an initial time synchronization error is less than the CP duration, the second UE can implement time synchronization by using a frequency domain synchronization algorithm; and compared with a time-domain-related synchronization algorithm, the frequency domain synchronization algorithm has lower complexity. Therefore, greater duration of the symbol to which the first sequence is mapped can make the frequency domain algorithm tolerate a larger initial time synchronization error. In addition, the CP structure may be used for frequency synchronization, and a longer CP indicates more points used for frequency synchronization and higher frequency synchronization precision.

Based on any one of the foregoing solutions, optionally, a subcarrier spacing of the symbol to which the first sequence is mapped is greater than a subcarrier spacing of the symbol to which the data is mapped. The subcarrier spacing of the symbol of the first sequence is greater than the subcarrier spacing of the data symbol, so that overheads can be further reduced. A subcarrier spacing supported by NR may be used. This solution is easy to implement.

Optionally, the duration of the cyclic prefix of the symbol to which the first sequence is mapped is less than duration of the symbol to which the first sequence is mapped.

Based on the foregoing solution, the CP of the symbol for the first sequence is smaller than the symbol for the first sequence, so that occurrence of two correlation peaks with similar values during time synchronization can be prevented, reducing additional complexity brought to processing by a receiver of the second UE.

In a specific implementation of any one of the foregoing solutions, the mapping, by first UE, a first sequence to a symbol of the first time unit includes: consecutively mapping, by the first UE, the first sequence in a frequency domain corresponding to a symbol corresponding to the first sequence, where a remaining frequency domain part is filled with o or the first sequence is cyclically mapped to a remaining frequency domain part.

In this solution, the UE continuously maps the first sequence in the frequency domain corresponding to the symbol corresponding to the first sequence, excluding a manner of equally-spaced mapping. This reduces additional complexity that is brought to processing of a receiver because two correlation peaks with similar values from occur during time synchronization. In addition, filling the remaining frequency domain part with o can make a peak-to-average power ratio of the first signal transmitted by the first UE lower, a time domain distortion of the synchronization sequence smaller, and synchronization performance better. The cyclically mapped first sequence may be used for channel estimation, and measurement of signal received power and signal received quality.

Based on any one of the foregoing solutions, a second sequence is mapped to at least one symbol, starting from the 1^{st} symbol, of the first time unit, and the second sequence is a quadrature phase shift keying (QPSK) sequence, a BPSK sequence, or a constant amplitude zero auto-correlation (CAZAC) sequence. The second sequence may be used by the second UE to perform AGC.

Optionally, a subcarrier spacing of the 1^{st} symbol to which the second sequence is mapped is greater than the subcarrier spacing of the symbol to which the data is mapped. When the second sequence is mapped to only one symbol, overheads can be reduced. When the second sequence is mapped to a plurality of symbols, a time granularity may be smaller; and a quantity of symbols may be more flexibly configured, so that total overheads are smaller.

Based on any one of the foregoing solutions, the first sequence is mapped to the 2^{nd} symbol of the first time unit. That is, when the second sequence is mapped to only the 1^{st} symbol, and is mapped to only one symbol, the first sequence can be mapped to the 2^{nd} symbol. When the second sequence is mapped to a plurality of symbols, the first sequence is mapped to an immediately following symbol.

Based on the foregoing embodiments, an OFDM symbol is used as an example. A specific implementation manner of the synchronization method is as follows: A system uses a multiple access manner of time division multiple access (TDMA), to avoid damage to orthogonality of the OFDM system because an arrival time difference between different data exceeds CP duration when data is sent by different UEs in a frequency division multiplexing (FDM) manner. An SCS of 120 kHz or 240 kHz of the symbol is used by the UE to transmit data, where CP duration is corresponding NCP or ECP duration in Table 1 in the background.

The preamble sequence shown in FIG. 1 is sent on a starting part of each data transmission (one TTI (sTTI) or a plurality of consecutive bundled TTIs (sTTIs)) and the last one or half symbol at the end is a guard period in which no data is sent, to prevent interference caused due to overlapping of an end at which specific UE or some specific UEs receive the data transmission and a starting part of data transmission by another UE.

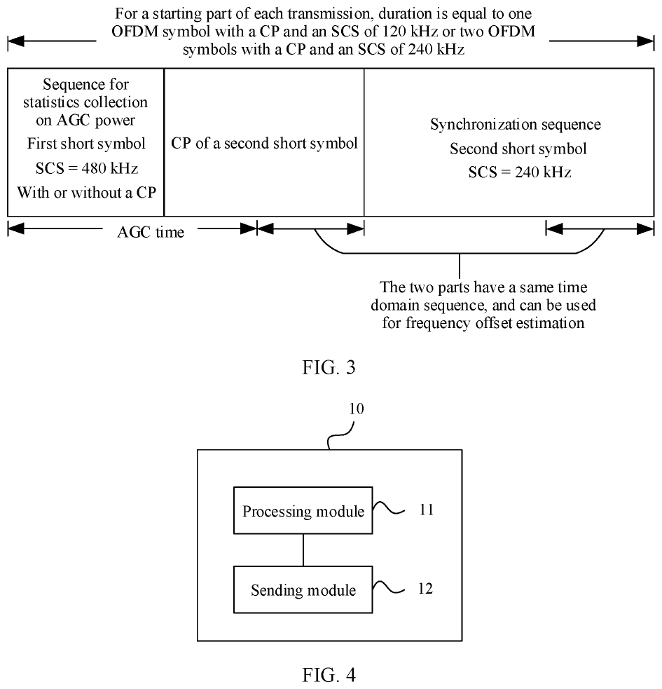

FIG. 3 is a schematic diagram of a preamble sequence in an example of a synchronization method according to this application. In the preamble sequence shown in FIG. 3, CP duration of a second short symbol is definitely greater than CP duration of an OFDM symbol whose data transmission SCS is 120 kHz or 240 kHz.

A sequence used for statistics collection on AGC power is a frequency domain M sequence or a frequency domain ZC sequence, and is mapped in frequency domain at equal intervals, and a part that is not covered by the mapping may be filled with o or the sequence is cycled. A sequence used for synchronization is a frequency domain M sequence or a frequency domain ZC sequence, and is mapped in frequency domain continuously, and a part that is not covered by the mapping may be filled with 0 or the sequence is cycled.

In a structure of the preamble sequence shown in FIG. 3, different subcarrier spacings are used in OFDM symbols for sending an AGC sequence and a synchronization sequence, so that the CP duration of the second short symbol is sufficiently long when duration overheads of one OFDM symbol with a CP and an SCS of 120 kHz or two OFDM symbols with a CP and an SCS of 240 kHz are used. This effectively controls overheads.

In the synchronization method provided in this embodiment, a preamble sequence with duration of one OFDM symbol with a CP and an SCS of 120 kHz or two OFDM symbols with a CP and an SCS of 240 kHz is sent during each data transmission, so that the UE implements AGC and time and frequency synchronization on data sent by another UE within a communication distance. The CP duration of the second short symbol is greater than the CP duration of the data sending symbol with the SCS of 120 kHz or 240 kHz, so that when the CP duration of the data sending OFDM symbol cannot meet a time synchronization requirement, the receiver can still implement time synchronization on currently received data by using a low-complexity algorithm used for implementing time synchronization by solving a time domain channel. A starting part of the CP is used to overcome interference of a current symbol to a next symbol caused by channel delay spread, and a remaining part may be used for frequency offset estimation. In addition, a longer CP indicates a longer sequence used for frequency offset estimation. This can improve frequency offset estimation precision.

In this solution, that the UE transmits, at a location of a second short symbol for each data transmission, a sequence used to for synchronization of the receive UE is a main improvement between the technical solution in this application and a technical solution of prior art 1. To be distinguished from an existing technology of transmitting a reference signal sequence each time, CP duration of a synchronization-sequence sending symbol is greater than CP duration of a data sending symbol.

With reference to the foregoing embodiments and examples, it can be learned that, according to the synchronization method provided in this solution, the first sequence is sent on one OFDM symbol on a non-starting part of each data transmission, and CP duration of the OFDM symbol for sending the first sequence is greater than the CP duration of the data sending symbol. When the CP duration of the OFDM symbol for sending data cannot meet a time synchronization requirement, the receiver can still implement time synchronization on the currently received data by using a low-complexity algorithm used for implementing time synchronization by solving a time domain channel.

The first sequence is sent on an OFDM symbol with a CP on a non-starting part of each data transmission, and the receiver may perform frequency offset estimation by using a CP structure, to implement frequency synchronization. A part from a starting part of the CP is used to overcome interference of a current symbol to a next symbol caused by channel delay spread, and a remaining part is the same as an end-part sequence of a corresponding OFDM symbol and may be used for frequency offset estimation of the receiver. A longer CP indicates a longer sequence used for frequency offset estimation. This can improve frequency offset estimation precision, thereby improving frequency synchronization performance.

FIG. 4 is a schematic structural diagram of Embodiment 1 of a synchronization apparatus according to this application. As shown in FIG. 4, the synchronization apparatus 10 provided in this embodiment includes: a processing module ii, configured to map to-be-transmitted data and a first sequence to a symbol of a first time unit, to obtain a first signal, where the first sequence is mapped to at least one symbol of the first time unit except the 1^{st} symbol, and the first sequence is used by second UE to perform synchronization the first signal; and a sending module 12, configured to send the first signal to the second UE.

The synchronization apparatus provided in this embodiment is configured to implement the synchronization method on a first device side provided by any one of the foregoing implementation manners. Implementation principles and technical effects of the synchronization apparatus are similar to those of the synchronization method. A first sequence used for user synchronization is sent in a symbol of a non-starting part of each data transmission, so that when CP duration of a data sending symbol cannot satisfy a time synchronization requirement, the second UE can still implement time synchronization on the currently received data by using a low-complexity algorithm used for implementing time synchronization by solving a time-domain channel, and implement frequency synchronization by performing frequency offset estimation by using a CP structure.

In a specific implementation of the synchronization apparatus 10, duration of a cyclic prefix of the symbol to which the first sequence is mapped is greater than duration of a cyclic prefix of a symbol to which the data is mapped.

Optionally, a subcarrier spacing of the symbol to which the first sequence is mapped is greater than a subcarrier spacing of the symbol to which the data is mapped.

Optionally, the duration of the cyclic prefix of the symbol to which the first sequence is mapped is less than duration of the symbol to which the first sequence is mapped.

Optionally, the mapping, by first UE, a first sequence to a symbol of a first time unit includes: consecutively mapping, by the first UE, the first sequence in a frequency domain corresponding to a symbol corresponding to the first sequence, where a remaining frequency domain part is filled with 0 or the first sequence is cyclically mapped to a remaining frequency domain part.

Optionally, a second sequence is mapped to at least one symbol, starting from the 1^{st} symbol, of the first time unit, and the second sequence is a QPSK sequence, a BPSK sequence, or a CAZAC sequence.

Optionally, a subcarrier spacing of the 1^{st} symbol to which the second sequence is mapped is greater than the subcarrier spacing of the symbol to which the data is mapped.

Optionally, the first sequence is mapped to the 2^{nd} symbol of the first time unit.

Optionally, when the second sequence is mapped to the 1^{st} symbol of the first time unit, the first sequence is mapped to the 2^{nd} symbol of the first time unit.

When the second sequence is mapped to a plurality of symbols, starting from the 1^{st} symbol, of the first time unit, the first sequence is mapped to a symbol following the symbols for the second sequence.

Optionally, the first time unit includes: one subframe, one TTI, one sTTI, a plurality of bundled consecutive TTIs, or a plurality of bundled consecutive sTTIs.

Optionally, the processing module 11 is further configured to: determine the first sequence based on a preconfigured synchronization sequence set; obtain the first sequence preconfigured in a protocol; or determine the first sequence based on received information sent by a base station.

The synchronization apparatuses provided in the foregoing implementation solutions are configured to implement the technical solutions of the first UE in the method embodiments. Implementation principles and technical effects of the synchronization apparatuses are similar to those of the method embodiments, and details are not described herein again.

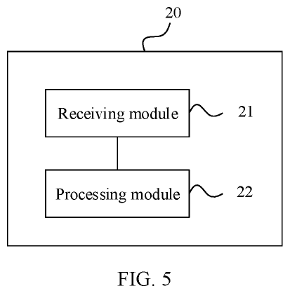

FIG. 5 is a schematic structural diagram of Embodiment 2 of a synchronization apparatus according to this application. As shown in FIG. 5, the synchronization apparatus 20 provided in this embodiment includes: a receiving module 21, configured to receive a first signal sent by first UE, where the first signal includes data and a first sequence, and the first sequence is mapped to at least one symbol of a first time unit except the 1^{st} symbol; and a processing module 22, configured to perform synchronization on the first signal based on the first sequence.

The synchronization apparatus provided in this embodiment is configured to implement the technical solution of the second UE in any one of the foregoing method embodiments. Implementation principles and technical solutions of the synchronization apparatus are similar to those of the method embodiments, and details are not described herein again.

Based on the foregoing embodiments, the processing module 22 is specifically configured to: obtain a frequency offset and a timing offset between the data and a carrier frequency; and obtain, based on the frequency offset and the timing offset, the data transmitted in the data signal.

Optionally, duration of a cyclic prefix of the symbol to which the first sequence is mapped is greater than duration of a cyclic prefix of a symbol to which the to-be-transmitted data is mapped.

Optionally, a subcarrier spacing of the symbol to which the first sequence is mapped is greater than a subcarrier spacing of the symbol to which the data is mapped.

Optionally, the duration of the cyclic prefix of the symbol to which the first sequence is mapped is less than duration of the symbol to which the first sequence is mapped.

Optionally, a second sequence is mapped to at least one symbol, starting from the 1^{st} symbol, of the first time unit, and the second sequence is a QPSK sequence, a BPSK sequence, or a CAZAC sequence.

Optionally, a subcarrier spacing of the 1^{st} symbol to which the second sequence is mapped is greater than the subcarrier spacing of the symbol to which the data is mapped.

Optionally, the receiving module 21 is specifically configured to: receive the first sequence in the 2^{nd} symbol of the first time unit.

That is, the first sequence is mapped to the 2^{nd} symbol of the first time unit.

Optionally, when the second sequence is mapped to the 1^{st} symbol of the first time unit, the first sequence is mapped to the 2^{nd} symbol of the first time unit.

When the second sequence is mapped to a plurality of symbols, starting from the 1^{st} symbol, of the first time unit, the first sequence is mapped to a symbol following the symbols for the second sequence.

Optionally, the first time unit includes: one subframe, one TTI, one sTTI, a plurality of bundled consecutive TTIs, or a plurality of bundled consecutive sTTIs.

Optionally, the processing module 22 is further configured to: detect the first signal based on a preconfigured synchronization sequence set, to obtain a sequence that is carried in the first signal and that belongs to the synchronization sequence set, and determine the sequence as the first sequence; detect the first signal based on a synchronization sequence preconfigured in a protocol, to obtain the first sequence; or detect the first signal based on a synchronization sequence determined by using received information sent by a base station, to obtain the first sequence.

The synchronization apparatus provided in any one of the foregoing embodiments is configured to implement the technical solution of the second UE in any one of the foregoing method embodiments. Implementation principles and technical solutions of the synchronization apparatus are similar to those of the method embodiments, and details are not described herein again.

This application further provides user equipment, including a memory, a processor, a transmitter, and a computer program. The computer program is stored in the memory, and the processor runs the computer program to perform the synchronization method on the first UE side provided in any one of the foregoing embodiments.

This application further provides user equipment, including a memory, a processor, a receiver, and a computer program. The computer program is stored in the memory, and the processor runs the computer program to perform the synchronization method on the second UE side provided in any one of the foregoing embodiments.

During specific implementation of the foregoing user equipments, the memory may be integrated into the processor. There is at least one processor configured to execute an executable instruction stored in the memory, namely, the computer program.

This application further provides a storage medium, including a readable storage medium and a computer program. The computer program is used to implement the synchronization method on the first UE side provided in any one of the foregoing embodiments.

This application further provides a storage medium, including a readable storage medium and a computer program. The computer program is used to implement the synchronization method on the second UE side provided in any one of the foregoing embodiments.

This application further provides a program product. The program product includes a computer program (namely, an executable instruction), and the computer program is stored in a readable storage medium. At least one processor of the user equipment may read the computer program from the readable storage medium, and the at least one processor executes the computer program, so that the user equipment implements the synchronization method of the synchronization method on the first UE side or on the second UE side provided in any one of the foregoing embodiments.

This application further provides a chip. The chip is applicable to user equipment, and the chip includes: at least one communications interface, at least one processor, and at least one memory. The communications interface, the memory, and the processor are interconnected by using a bus; and the processor invokes a computer program stored in the memory, to perform the technical solution of the synchronization method on the first UE side or on the second UE side in this application.

In a specific implementation of the user equipment, it should be understood that the processor may be a central processing unit (CPU), or may be another general-purpose processor, a digital signal processor (DSP), an application-specific integrated circuit (ASIC), or the like. The general-purpose processor may be a microprocessor, or the processor may be any conventional processor or the like. The steps of the methods disclosed with reference to this application may be directly implemented by a hardware processor, or may be implemented by a combination of hardware and a software module in a processor.

All or some of the steps of the foregoing method embodiments may be implemented by a program instructing relevant hardware. The foregoing program may be stored in a computer-readable memory. When the program is executed, the steps of the methods in the embodiments are performed. The memory (storage medium) includes: a read-only memory (ROM), a RAM, a flash memory, a hard disk, a solid-state disk, a magnetic tape, a floppy disk, an optical disc, and any combination thereof.

What is claimed is:

1. A method, comprising:
mapping, by first user equipment (UE), to-be-transmitted data and a first sequence to symbols of a first time unit, to obtain a first signal, wherein the first sequence is mapped to one or more first symbols of the first time unit, the one or more first symbols do not include an earliest symbol of the first time unit, and the first sequence is usable by second UE to perform synchronization with the first signal; and
sending, by the first UE, the first signal to the second UE.

2. The method according to claim 1, wherein a duration of a cyclic prefix of the one or more first symbols to which the first sequence is mapped is greater than duration of a cyclic prefix of one or more second symbols to which the to-be-transmitted data is mapped.

3. The method according to claim 1, wherein a subcarrier spacing of the one or more first symbols to which the first sequence is mapped is greater than a subcarrier spacing of one or more second symbols to which the to-be-transmitted data is mapped.

4. The method according to claim 1, wherein a duration of a cyclic prefix of the one or more first symbols to which the first sequence is mapped is less than a duration of the one or more first symbols to which the first sequence is mapped.

5. The method according to claim 1, wherein mapping, by the first UE, the first sequence to the one or more first symbols of the first time unit comprises:
consecutively mapping, by the first UE, the first sequence in a frequency domain pail, wherein a remaining frequency domain part is filled with 0, or the first sequence is cyclically mapped to a remaining frequency domain part.

6. The method according to claim 1, wherein a second sequence is mapped to one or more third symbols of the first time unit, starting from the earliest symbol of the first time unit, and the second sequence is a quadrature phase shift keying (QPSK) sequence, a binary phase shift keying (BPSK) sequence, or a constant amplitude zero auto-correlation (CAZAC) sequence.

7. The method according to claim 6, wherein a subcarrier spacing of the one or more third symbols to which the second sequence is mapped is greater than the subcarrier spacing of the one or more second symbols to which the to-be-transmitted data is mapped.

8. The method according to claim 1, wherein the first sequence is mapped to a 2^{nd} symbol of the first time unit.

9. The method according to claim 1, wherein the first time unit comprises: one subframe, one transmission time interval (TTI), one short transmission time interval (sTTI), a plurality of bundled consecutive (TTIs), or a plurality of bundled consecutive (sTTIs).

10. The method according to claim 1, wherein before mapping, by the first UE, the to-be-transmitted data and the first sequence to symbols of a first time unit, to obtain the first signal, the method further comprises:
determining the first sequence based on a preconfigured synchronization sequence set;
obtaining the first sequence preconfigured in a protocol; or
determining the first sequence based on received information sent by a base station.

11. An apparatus, comprising:
a processor; and
a non-transitory computer-readable storage medium storing a program to be executed by the processor, the program including instructions to:
receive a first signal sent by first user equipment (UE), wherein the first signal comprises data and a first sequence, the first sequence is mapped to one or more first symbols of a first time unit, and the one or more first symbols do not include an earliest symbol of the first time unit; and
perform synchronization on the first signal based on the first sequence.

12. The apparatus according to claim 11, wherein performing synchronization on the first signal based on the first sequence comprises:
obtaining a frequency offset and a timing offset between the data and a carrier frequency; and
obtaining, based on the frequency offset and the timing offset, the data transmitted in the first signal.

13. The apparatus according to claim 11, wherein a duration of a cyclic prefix of the one or more first symbols to which the first sequence is mapped is greater than a duration of a cyclic prefix of one or more second symbols to which the data is mapped.

14. The apparatus according to claim 11, wherein a subcarrier spacing of the one or more first symbols to which the first sequence is mapped is greater than a subcarrier spacing of one or more second symbols to which the data is mapped.

15. The apparatus according to claim 11, wherein a duration of a cyclic prefix of the one or more first symbols to which the first sequence is mapped is less than a duration of the one or more first symbols to which the first sequence is mapped.

16. An apparatus, comprising:
a processor; and
a non-transitory computer-readable storage medium storing a program to be executed by the processor, the program including instructions to:
map to-be-transmitted data and a first sequence to symbols of a first time unit, to obtain a first signal, wherein the first sequence is mapped to one or more symbols of the first time unit, the one or more first symbols of the first time unit do not comprise an earliest symbol of the first time unit, and the first sequence is usable by a second user equipment (UE) to perform synchronization the first signal; and
send the first signal to the second UE.

17. The apparatus according to claim 16, wherein a duration of a cyclic prefix of the one or more first symbols to which the first sequence is mapped is greater than duration of a cyclic prefix of one or more second symbols to which the to-be-transmitted data is mapped.

18. The apparatus according to claim 17, wherein a subcarrier spacing of the one or more first symbols to which the first sequence is mapped is greater than a subcarrier spacing of the one or more second symbols to which the to-be-transmitted data is mapped.

19. The apparatus according to claim 16, wherein the program further includes instructions to:
determine the first sequence based on a preconfigured synchronization sequence set.

20. The apparatus according to claim 16, wherein the program further includes instructions to:
obtain the first sequence preconfigured in a protocol; or
determine the first sequence based on received information sent by a base station.
